(19) United States
(12) Patent Application Publication
(10) Pub. No.: US 2026/0188116 A1
(43) Pub. Date: Jul. 2, 2026

(54) DRIVING ASSISTANCE DEVICE, DRIVING ASSISTANCE METHOD, AND NON-TRANSITORY COMPUTER-READABLE STORAGE MEDIUM

(71) Applicant: HONDA MOTOR CO., LTD., Tokyo (JP)

(72) Inventors: Kohei MATSUDA, Saitama (JP); Kiri YOSHIDA, Saitama (JP); Kenjiro TORII, Saitama (JP); Shigenobu SAIGUSA, Tokyo (JP); Youngjun AN, Tokyo (JP)

(21) Appl. No.: 19/407,924

(22) Filed: Dec. 3, 2025

(30) Foreign Application Priority Data
Dec. 26, 2024 (JP) 2024-229724

(51) Int. Cl. G08G 1/0967

(52) U.S. Cl. CPC G08G 1/096733

(57) ABSTRACT

A driving assistance device for a vehicle includes: a notification device provided inside a cabin of the vehicle; and a control device that controls the notification device, wherein the control device is configured to set, on a merging lane that merges with a main lane, an acceleration start point before a merging start point where a lane change from the merging lane to the main lane becomes possible, and cause the notification device to output an acceleration notification prompting a driver to perform an acceleration operation when the vehicle arrives at the acceleration start point.

### TECHNICAL FIELD

The present invention relates to a driving assistance device, a driving assistance method, and a control program (stored in a non-transitory computer-readable storage medium).

### BACKGROUND ART

In recent years, there has been an increase in efforts to provide sustainable transportation systems that take into account people in vulnerable situations among traffic participants. To realize this, research and development related to driving assistance technology and autonomous driving technology are conducted to further improve the safety and convenience of traffic.

A merging operation from the merging lane to the main lane in expressways or the like is an operation that tends to be stressful for the driver. JP2019-26060A discloses a driving assistance device for a vehicle capable of conducting adaptive cruise control for maintaining the inter-vehicle distance to the preceding vehicle, wherein in the case where there is a following vehicle after merging into the main lane, the driving assistance device corrects the acceleration to increase it thereby to increase the inter-vehicle distance to the following vehicle.

However, in the driving assistance device disclosed in JP2019-26060A, since the vehicle speed is controlled by the adaptive cruise control, if the set target speed is low, the vehicle may be caused to change lanes to the main lane at a low speed, and this may make the lane change difficult. Success or failure of the merging operation largely depends on whether the vehicle has reached a sufficient speed on the merging lane. Therefore, if it is possible to prompt the driver to accelerate appropriately on the merging lane, the merging operation becomes relatively easy.

### SUMMARY OF THE INVENTION

In view of the foregoing background, an object of one aspect of the present invention is to provide a driving assistance device, a driving assistance method, and a control program that can prompt the driver to accelerate appropriately when the vehicle is on the merging lane.

To achieve the above object, one aspect of the present invention provides a driving assistance device for a vehicle, the driving assistance device comprising: a notification device provided inside a cabin of the vehicle; and a control device that controls the notification device, wherein the control device is configured to set, on a merging lane that merges with a main lane, an acceleration start point before a merging start point where a lane change from the merging lane to the main lane becomes possible, and cause the notification device to output an acceleration notification prompting a driver to perform an acceleration operation when the vehicle arrives at the acceleration start point.

Another aspect of the present invention provides a driving assistance method for a vehicle, wherein the driving assistance method is to be executed by a computer and comprises: setting, on a merging lane that merges with a main lane, an acceleration start point before a merging start point where a lane change from the merging lane to the main lane becomes possible; and causing a notification device to output an acceleration notification prompting a driver to perform an acceleration operation when the vehicle arrives at the acceleration start point.

Another aspect of the present invention provides a non-transitory computer-readable storage medium, comprising a stored control program, the control program configured to cause a computer to execute a driving assistance method for a vehicle, the driving assistance method comprising: setting, on a merging lane that merges with a main lane, an acceleration start point before a merging start point where a lane change from the merging lane to the main lane becomes possible; and causing a notification device to output an acceleration notification prompting a driver to perform an acceleration operation when the vehicle arrives at the acceleration start point.

According to the above aspects of the present invention, a driving assistance device, a driving assistance method, and a control program that can prompt the driver to accelerate appropriately when the vehicle is on the merging lane can be provided.

### BRIEF DESCRIPTION OF THE DRAWINGS

FIG. 1 is a configuration diagram of a driving assistance device according to an embodiment;

FIG. 2 is an explanatory diagram of a merging lane;

FIG. 3 is a perspective view showing a cabin of a vehicle; and

FIG. 4 is a flowchart showing a procedure of driving assistance control executed by a control device.

### DETAILED DESCRIPTION OF THE INVENTION

In the following, embodiments of a driving assistance device, a driving assistance method, and a control program will be described with reference to the drawings.

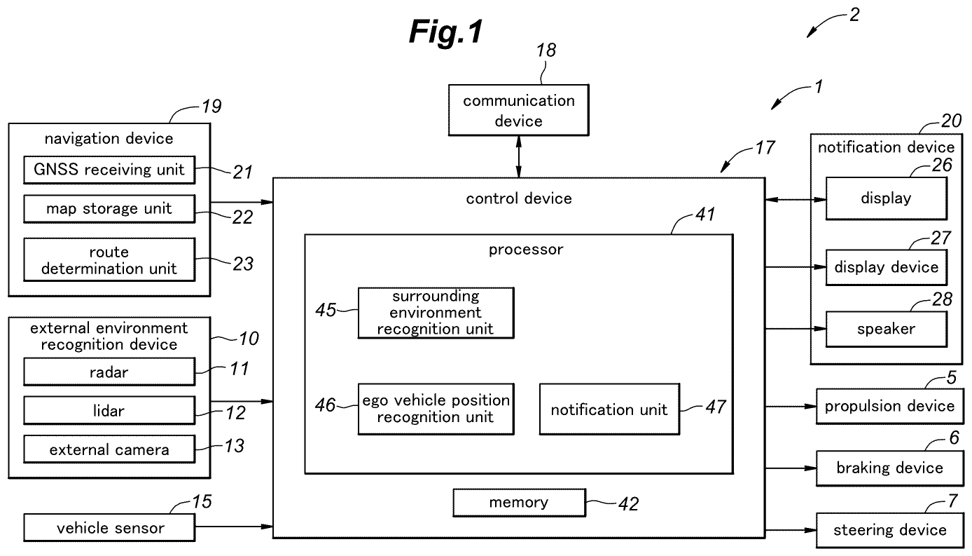

As shown in FIG. 1, a driving assistance device 1 is provided in a vehicle 2. The vehicle 2 may be a four-wheeled automobile, for example.

The vehicle 2 includes a propulsion device 5, a braking device 6, and a steering device 7. The propulsion device 5 is a device for providing a driving force to the vehicle 2 and includes a power source and a transmission, for example. The power source includes at least one of an internal combustion engine, such as a gasoline engine or a diesel engine, and an electric motor. The braking device 6 is a device for applying a braking force to the vehicle 2 and includes a brake caliper for pressing a pad against a brake rotor and an electric cylinder for supplying hydraulic pressure to the brake caliper, for example. The steering device 7 is a device for changing the steering angle of the wheels and includes a rack-and-pinion mechanism for steering the wheels and an electric motor for driving the rack-and-pinion mechanism, for example.

The vehicle 2 includes an external environment recognition device 10. The external environment recognition device 10 is a device that detects objects outside the vehicle 2. The external environment recognition device 10 is a sensor that detects objects or the like outside the vehicle 2 by capturing electromagnetic waves or light from the surroundings of the vehicle 2. The external environment recognition device 10 includes a radar 11, a lidar 12, and an external camera 13, for example.

The vehicle 2 includes a vehicle sensor 15. The vehicle sensor 15 includes a vehicle speed sensor that detects the speed of the vehicle 2 and an acceleration sensor that detects the acceleration of the vehicle 2. The vehicle sensor 15 may include a yaw rate sensor that detects an angular velocity around a vertical axis, a direction sensor that detects the direction of the vehicle 2, etc.

The vehicle 2 includes a control device 17, a communication device 18, a navigation device 19, and a notification device 20 serving as a human machine interface (HMI). The communication device 18 mediates the communication of the control device 17 and the navigation device 19 with a nearby vehicle and a server located outside the vehicle 2.

The navigation device 19 is a device that acquires the current position of the vehicle 2 and provides route guidance to the destination and other functions. The navigation device 19 preferably includes a global navigation satellite system (GNSS) receiving unit 21, a map storage unit 22, and a route determination unit 23. The GNSS receiving unit 21 identifies the position (latitude and longitude) of the vehicle 2 based on signals received from artificial satellites (positioning satellites). The map storage unit 22 is composed of a known storage device such as a flash memory or a hard disk and stores map information.

The map information includes road information which includes types of roads such as expressways, toll roads, national highways, and prefectural roads, the number of lanes of each road, the center position (three-dimensional coordinate including a longitude, a latitude, and a height) of each lane, shapes of road markings such as road delimiting lines and lane boundaries, presence or absence sidewalks, curbs, fences, etc., intersection positions, positions of merging and branching points of each lane, positions of emergency parking zones, the width of each lane, signs provided on the roads, and so on. Also, map information may include traffic regulation information, address information (address and post code), facility information, telephone number information, and so on.

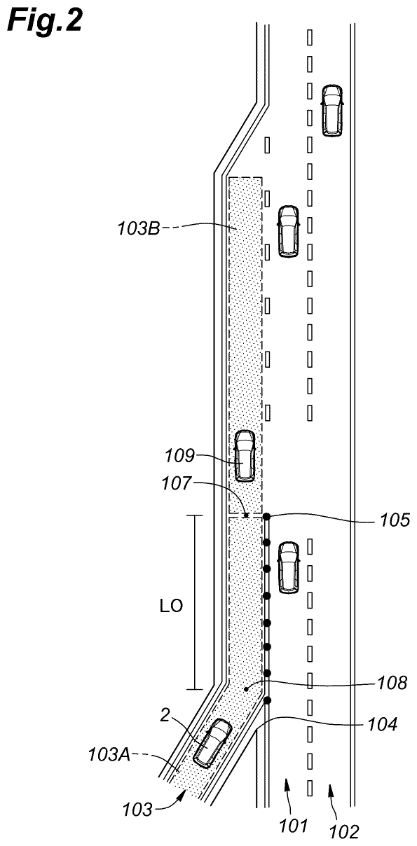

In the present embodiment, the map information includes information on whether the road is a main lane 101, 102 or a merging lane 103 that merges with the main lane 101. As shown in FIG. 2, the merging lane 103 includes a merging preparation section 103A and a mergeable section 103B. The mergeable section 103B extends in parallel with the main lane 101. The vehicle 2 can change lanes into the main lane 101 in the mergeable section 103B. The merging preparation section 103A is separated from the main lane 101 by a hard nose 104, such as walls, and a soft nose 105, such as traffic poles. The beginning point of the mergeable section 103B, namely, the ending point of the merging preparation section 103A is referred to as a merging start point 107. Namely, from the merging start point 107, the mergeable section 103B begins and the vehicle 2 becomes able to change lanes into the main lane 101. The merging start point 107 is preferably set at the ending point of the soft nose 105.

The merging preparation section 103A is an entrance ramp of an expressway, for example. The beginning point of the merging preparation section 103A is a preset arbitrary point. In the case where the merging lane 103 is an entrance ramp of an expressway, for example, the beginning point of the merging preparation section 103A may be the beginning point of the entrance ramp, a toll gate, or a branching point after passing the toll gate.

As information related to the merging lane 103, the map information preferably includes information on whether the merging lane 103 is the merging preparation section 103A or the mergeable section 103B, the position of the beginning point of the merging preparation section 103A, the position of the merging start point 107 (the position of the ending point of the merging preparation section 103A), the length of the merging preparation section 103A, the gradient at various points in the merging preparation section 103A, and the radius of curvature or the curve radius (R) of the merging preparation section 103A.

The notification device 20 notifies the occupant of various kinds of information by display and/or voice. The notification device 20 is provided in the cabin 25 of the vehicle 2. As shown in FIG. 1, the notification device 20 preferably includes a display 26 including a liquid crystal display, an organic EL display or the like, a display device 27, and a speaker 28.

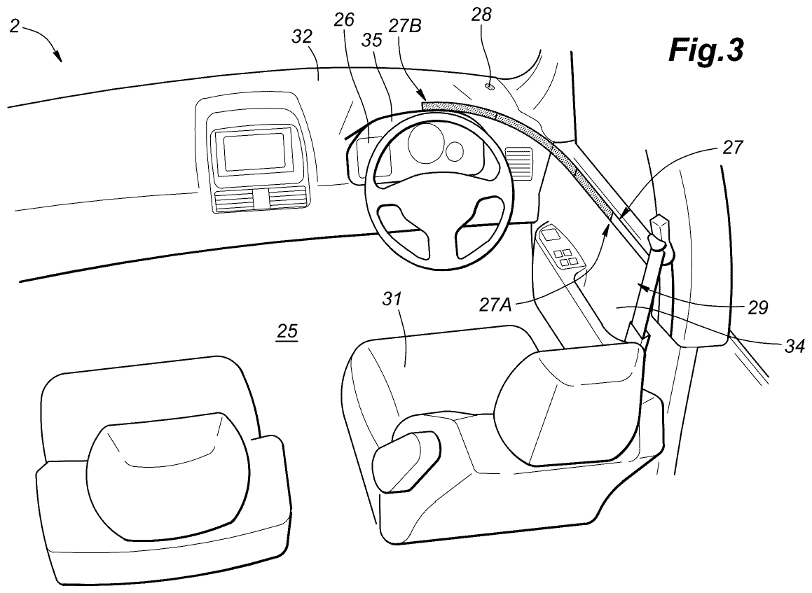

The display device 27 is an optical device for visually providing information to the driver. The display device 27 may be composed of light emitting elements (light sources) such as light emitting diodes (LEDs) or a liquid crystal display. The display device 27 may be a so-called ambient light. As shown in FIG. 3, the display device 27 is provided in the cabin 25 of the vehicle 2 and extends in a predetermined direction. The display device 24 has multiple display regions 27 divided in the extension direction thereof.

In the present embodiment, the display device 27 includes a first part 27A and a second part 27B. The first part 27A is provided on a door 29 constituting a side portion of the cabin 25 and extends in the front-rear direction. The door 29 is disposed on a side of the driver's seat 31. The second part 27B is provided on an instrument panel 32 constituting a front portion of the cabin 25 and extends laterally. The front end of the first part 27A and the right end, which is one end, of the second part 27B are disposed close to each other. Thereby, the second part 27B extends leftward from the front end of the first part 27A. Preferably, the first part 27A and the second part 27B extend linearly in a continuous manner.

The first part 27A preferably extends in the front-rear direction in an upper portion of a door lining 34 of the door 29. The second part 27B is preferably provided along an upper edge of a meter panel 35 provided in the instrument panel 32. The left end of the second part 27B is preferably disposed above the central part of the meter panel 35.

The display device 27 can change the display mode. The display mode includes a light emitting region, an emission color, and a light emitting period. For example, the display device 27 can set the display mode such that the light emitting region moves from the rear to the front. Also, the display device 27 can change the moving speed of the light emitting region.

The display device 27 may be provided in a left side portion of the cabin 25. Preferably, the display device 27 on the left side is formed as a mirror image of the display device 27 on the right side. Also, the display device 27 may be provided on the instrument panel 32.

The display 26 may be a touch panel display. The display 26 is preferably provided on the instrument panel 32. Also, the display 26 may be disposed in the meter panel 35.

As shown in FIG. 1, the control device 17 is a computer including a processor 41 and a memory 42 communicatively connected to the processor 41. The processor 41 preferably includes, as a core, at least one of a central processing unit (CPU), a graphics processing unit (GPU), and a reduced instruction set computer (RISC), for example. The memory 42 stores a control program executed by the processor 41 and various data. The memory 42 preferably includes at least one of a volatile memory and a non-volatile memory. The volatile memory may be a dynamic random access memory (DRAM) or a static random access memory (SRAM), for example. The non-volatile memory may be a solid state drive (SSD), a flash memory, a magnetic disk storage device, or an optical disk storage device. At least a part of the control device 17 may be realized by hardware such as a large scale integration (LSI) circuit, an application specific integrated circuit (ASIC), or a field-programmable gate array (FPGA) or may be realized by a combination of software and hardware. The control device 17 may be composed of one piece of hardware or may be composed of multiple pieces of hardware capable of communicating with each other. A part of the control device 17 may be configured by an external server provided outside the vehicle 2.

The processor 41 implements various applications by executing the control program stored in the memory 42. The control program may be stored in a removable recordable medium such as a DVD or a CD-ROM and may be installed into the memory 42 when the recordable medium is read by a reading device. Also, the control program may be downloaded via a communication network such as the internet and installed into the memory 42.

The driving assistance device 1 is a vehicle system and includes at least the control device 17 and the notification device 20 as the constituents thereof. Also, the driving assistance device 1 may include the external environment recognition device 10, the vehicle sensor 15, and the navigation device 19 as the constituents thereof.

The control device 17 controls the display device 27 and the speaker 28. By executing the control program stored in the memory 42, the processor 41 functions as a surrounding environment recognition unit 45, an ego vehicle position recognition unit 46, and a notification unit 47.

The surrounding environment recognition unit 45 recognizes the surrounding environment of the vehicle 2. The surrounding environment recognition unit 45 recognizes, based on the detection result of the external environment recognition device 10, the surrounding environment (external environment) including obstacles present around the vehicle 2, road shape, lane markings, presence or absence of sidewalks, road markings, etc. The obstacles include guardrails, utility poles, nearby vehicles, and persons such as pedestrians, for example. The surrounding environment recognition unit 45 can acquire a state, such as the position, velocity, and acceleration of each nearby vehicle from the detection result of the external environment recognition device 10.

The ego vehicle position recognition unit 46 recognizes the position of the vehicle 2 (ego vehicle). The ego vehicle position recognition unit 46 preferably recognizes the position of the vehicle 2 based on the GNSS signal received by the GNSS receiving unit 21.

The notification unit 47 of the control device 17 controls the notification device 20 according to the driving assistance method. The notification unit 47 executes the driving assistance control when the vehicle 2 is in the merging preparation section 103A of the merging lane 103. The notification unit 47 determines whether the vehicle 2 is in the merging preparation section 103A of the merging lane 103 based on the position of the vehicle 2 acquired by the ego vehicle position recognition unit 46 and the map information.

In the driving assistance control, the notification unit 47 of the control device 17 sets, on the merging lane 103 that merges with the main lane 101, an acceleration start point 108 before (or upstream of) the merging start point 107 where the lane change from the merging lane 103 to the main lane 101 becomes possible. The merging start point 107 may be stored in the map information in advance. The notification unit 47 may set the position of the tip of the soft nose 105 stored in the map information as the merging start point 107. Also, the notification unit 47 may set the position of the tip of the soft nose 105 recognized by the surrounding environment recognition unit 45 as the merging start point 107.

Preferably, the notification unit 47 sets, as the acceleration start point 108, a position that is displaced from the merging start point 107 toward the upstream side, namely, toward the beginning point of the merging lane 103, by a predetermined offset distance LO along the merging lane 103. The offset distance LO is the distance between the acceleration start point 108 and the merging start point 107. The offset distance LO may be a preset value or may be set based on the state information of the vehicle 2, the driver characteristics information, and the merging lane information. The section from the acceleration start point 108 to the merging start point 107 may be referred to as an acceleration section.

Preferably, the notification unit 47 sets the offset distance LO based on the vehicle speed included in the state information of the vehicle 2. Preferably, the notification unit 47 sets the offset distance LO such that the lower the speed of the vehicle 2 is relative to a predetermined target speed, the greater the offset distance LO is. The target speed is preferably a value based on the statutory speed limit of the merging preparation section 103A or the main lane 101. For example, the target speed is preferably a value same as the statutory speed limit, or a value obtained by subtracting 10 km/h from the statutory speed limit. The target speed may be acquired from the map information, or may be acquired by the external environment recognizing unit recognizing the signs. Preferably, the notification unit 47 acquires the offset distance LO based on the difference between the speed of the vehicle 2 and the target speed by using a map in which the relationship of the offset distance LO with the difference between the speed of the vehicle 2 and the target speed is defined. Thereby, the notification unit 47 sets the acceleration start point 108 such that the lower the speed of the vehicle 2 is relative to the predetermined target speed, the greater the distance between the acceleration start point 108 and the merging start point 107 is.

The driver characteristics information includes driving characteristics, age, etc. of the driver, for example. The driving characteristics preferably include information related to the driving speed and acceleration by the driver, for example. For example, the driving characteristics may be represented as a score, such that a higher score indicates that the vehicle speed tends to be high, and a lower score indicates that the vehicle speed tends to be low. Preferably, the notification unit 47 sets the offset distance LO such that the smaller the driving characteristics score is, the greater the offset distance LO is. The notification unit 47 may acquire the offset distance LO based on the driving characteristics score by using a map in which the relationship between the driving characteristics score and the offset distance LO is defined. Thereby, the notification unit 47 sets the acceleration start point 108 based on the driver characteristics information. The driver characteristics information is preferably stored in the memory 42. The driver characteristics information may be created from past driving data. Also, the notification unit 47 may set the offset distance LO such that the higher the driver's age is, the greater the offset distance LO is.

The merging lane information preferably includes at least one of the radius of curvature and the gradient of the merging lane 103. The radius of curvature and the gradient of the merging lane 103 are preferably included in the map information. Preferably, the notification unit 47 sets the offset distance LO such that the smaller the radius of curvature of the merging lane 103 is, the greater the offset distance LO is. Also preferably, the notification unit 47 sets the offset distance LO such that the greater the upward gradient of the merging lane 103 is, the greater the offset distance LO is. The notification unit 47 may acquire the offset distance LO based on the merging lane information by using a map in which the relationship between the merging lane information and the offset distance LO is defined. Thereby, the notification unit 47 sets the acceleration start point 108 based on the merging lane information including at least one of the radius of curvature and the gradient of the merging lane 103.

In another embodiment, the notification unit 47 may set the position of the tip of the hard nose 104 as the acceleration start point 108.

The notification unit 47 of the control device 17 causes the notification device 20 to output an acceleration notification that prompts the driver to perform an acceleration operation when the vehicle 2 reaches the acceleration start point 108. The notification unit 47 preferably controls the speaker 28 to cause the speaker 28 to output the acceleration notification as a sound effect or voice. The acceleration notification outputted from the speaker 28 may be a voice output such as “Please accelerate,” for example. The notification unit 47 preferably controls the display 26 to cause the display 26 to output the acceleration notification as an image, video, or text. For example, the acceleration notification may be an icon depicting an accelerating vehicle or an icon depicting a depressed accelerator pedal. The notification unit 47 preferably controls the display device 27 to cause the display device 27 to output the acceleration notification as light emission. For example, the acceleration notification outputted from the display device 27 may be a forward movement of the light emitting region of the display device 27, blinking of the light emitting region, etc.

The notification unit 47 of the control device 17 causes the notification device 20 to output an inter-vehicle distance increase notification that prompts the driver to increase the inter-vehicle distance when the vehicle 2 is positioned before the acceleration start point 108 in the merging lane 103 and the inter-vehicle distance between the vehicle 2 and the preceding vehicle 109 thereof is smaller than a first target inter-vehicle distance. Also, the notification unit 47 causes the notification device 20 to output the inter-vehicle distance increase notification when the vehicle 2 is positioned on the merging lane 103 between the acceleration start point 108 and the merging start point 107 and the inter-vehicle distance between the vehicle 2 and the preceding vehicle 109 thereof is smaller than a second target inter-vehicle distance. The first target inter-vehicle distance is set greater than the second target inter-vehicle distance.

The surrounding environment recognition unit 45 recognizes the preceding vehicle 109 traveling in front of the vehicle 2 and acquires the inter-vehicle distance to the preceding vehicle 109. The notification unit 47 acquires the inter-vehicle distance to the preceding vehicle 109 from the surrounding environment recognition unit 45. The first target inter-vehicle distance and the second target inter-vehicle distance are preferably preset values.

The notification unit 47 preferably controls the speaker 28 to cause the speaker 28 to output the inter-vehicle distance increase notification as a sound effect or voice. The inter-vehicle distance increase notification outputted from the speaker 28 may be a voice output such as “Increase the inter-vehicle distance,” for example. The notification unit 47 preferably controls the display 26 to cause the display 26 to output the inter-vehicle distance increase notification as an image, video, or text. The inter-vehicle distance increase notification outputted from the display 26 may be an icon depicting a vehicle moving to increase the inter-vehicle distance or an icon depicting a decelerating vehicle, for example. The notification unit 47 preferably controls the display device 27 to cause the display device 27 to output the inter-vehicle distance increase notification as light emission. For example, the inter-vehicle distance increase notification outputted from the display device 27 may be a rearward movement of the light emitting region of the display device 27, blinking of the light emitting region, etc.

The notification unit 47 of the control device 17 preferably causes the notification device 20 to output a preparation notification that prompts the driver to prepare for an acceleration operation when the distance between the vehicle 2 and the acceleration start point 108 becomes less than or equal to a predetermined determination value. The notification unit 47 acquires the distance between the vehicle 2 and the acceleration start point 108 based on the position of the vehicle 2 acquired by the ego vehicle position recognition unit 46 and the position of the acceleration start point 108. The determination value is preferably a preset value, such as 50 m, for example.

The notification unit 47 preferably controls the speaker 28 to cause the speaker 28 to output the preparation notification as a sound effect or voice. The preparation notification outputted from the speaker 28 may be a voice output such as “The merging point is approaching,” for example. The notification unit 47 preferably controls the display 26 to cause the display 26 to output the preparation notification as an image, video, or text. The preparation notification outputted from the display 26 may be a text output such as “The merging point is approaching,” for example.

In the following, the control procedure of the driving assistance control executed by the control device 17 will be described. The control device 17 starts the driving assistance control when the vehicle 2 enters the merging preparation section 103A. The control device 17 determines whether the vehicle 2 is in the merging preparation section 103A based on the position of the vehicle 2 acquired by the ego vehicle position recognition unit 46 and the map information.

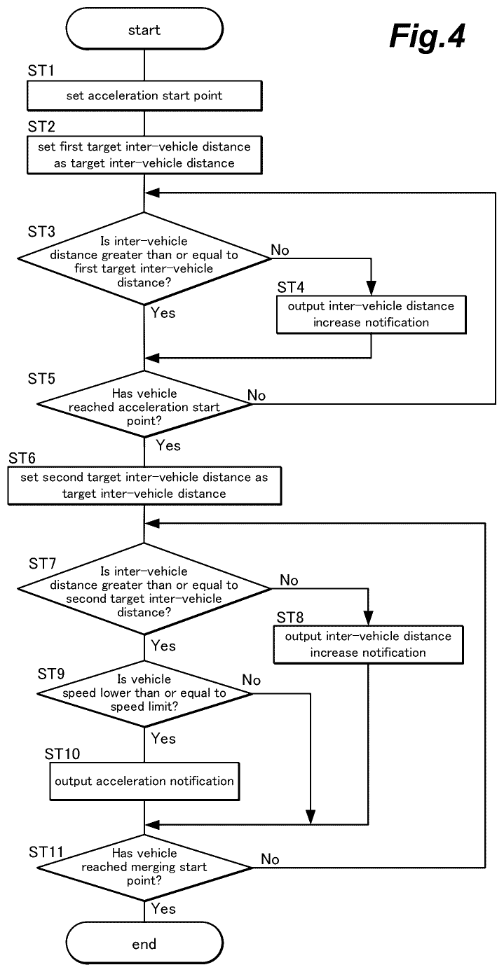

As shown in FIG. 4, first, the control device 17 sets the acceleration start point 108 (ST1). Preferably, the control device 17 acquires the merging start point 107 from the map information and sets the acceleration start point 108 based on the merging start point 107. For example, the control device 17 may acquire the vehicle speed, acquire the offset distance LO based on the vehicle speed, and set the acceleration start point 108 based on the merging start point 107 and the offset distance LO. Also, the control device 17 may set the acceleration start point 108 based on the driver characteristics information or the merging lane information, as described above.

Next, the control device 17 sets the first target inter-vehicle distance as the target inter-vehicle distance (ST2). Subsequently, the control device 17 determines whether the inter-vehicle distance between the vehicle 2 and the preceding vehicle 109 is greater than or equal to the first target inter-vehicle distance (ST3). In the case where the inter-vehicle distance between the vehicle 2 and the preceding vehicle 109 is less than the first target inter-vehicle distance (ST3: No), the control device 17 controls the notification device 20 to cause the notification device 20 to execute the inter-vehicle distance increase notification (ST4).

In the case where the inter-vehicle distance between the vehicle 2 and the preceding vehicle 109 is greater than or equal to the first target inter-vehicle distance (ST3: Yes) or the process in step ST4 is executed, then, the control device 17 determines whether the vehicle 2 has reached the acceleration start point 108 (ST5). Preferably, the position of the vehicle 2 is acquired by the ego vehicle position recognition unit 46.

In the case where the vehicle 2 has not reached the acceleration start point 108 (ST5: No), the process returns to step ST3, and the control device 17 repeats the processing in steps ST3 to ST5.

In the case where the vehicle 2 has reached the acceleration start point 108 (ST5: Yes), the control device 17 sets the second target inter-vehicle distance as the target inter-vehicle distance (ST6). Subsequently, the control device 17 determines whether the inter-vehicle distance between the vehicle 2 and the preceding vehicle 109 is greater than or equal to the second target inter-vehicle distance (ST7). In the case where the inter-vehicle distance between the vehicle 2 and the preceding vehicle 109 is less than the second target inter-vehicle distance (ST7: No), the control device 17 controls the notification device 20 to cause the notification device 20 to execute the inter-vehicle distance increase notification (ST8).

In the case where the inter-vehicle distance between the vehicle 2 and the preceding vehicle 109 is greater than or equal to the second target inter-vehicle distance (ST7: Yes), the control device 17 determines whether the vehicle speed is lower than or equal to the speed limit of the main lane 101 (ST9). Preferably, the control device 17 acquires the vehicle speed from the vehicle sensor 15 and acquires the speed limit of the main lane 101 from the map information. In the case where the vehicle speed is lower than or equal to the speed limit of the main lane 101 (ST9: Yes), the control device 17 controls the notification device 20 to cause the notification device 20 to output the acceleration notification (ST10).

In the case where the processing in step ST8 or step ST10 is executed or in the case where the vehicle speed is higher than the speed limit of the main lane 101 (ST9: No), the control device 17 determines whether the vehicle 2 has reached the merging start point 107 (ST11). In the case where the vehicle 2 has not reached the merging start point 107 (ST11: No), the process returns to step ST7, and the control device 17 repeats the processing in step ST7 to ST10. In the case where the vehicle 2 has reached the merging start point 107 (ST11: Yes), the control device 17 ends the driving assistance control.

According to the embodiment, the driving assistance device 1 that can prompt the driver to accelerate appropriately on the merging lane 103 can be provided. The driver can perform an acceleration operation at an appropriate timing on the merging lane 103 based on the acceleration notification. The control device 17 controls at least one of the display 26, the display device 27, the speaker 28 to perform the acceleration notification thereby to prompt the driver to perform an acceleration operation at a position before the merging start point 107.

Since the acceleration start point 108 is set before the merging start point 107, the driver performs an acceleration operation at a relatively early timing based on the acceleration notification. Thereby, the vehicle 2 driven by the driver is caused to accelerate at a timing earlier than the following vehicle. As a result, it is possible to widen the inter-vehicle distance between the vehicle 2 driven by the driver and the following vehicle by using the reaction delay of the following vehicle. Also, since the driver starts performing an acceleration operation before the merging start point 107, the vehicle 2 can reach a sufficient velocity when changing lanes.

Since, in the region before the acceleration start point 108, the control device 17 executes the inter-vehicle distance increase notification based on the first target inter-vehicle distance, which is greater than the second target inter-vehicle distance, the driver can perform an operation to increase the inter-vehicle distance to the preceding vehicle 109 based on the inter-vehicle distance increase notification. As a result, a sufficient inter-vehicle distance can be ensured between the preceding vehicle 109 and the vehicle 2 at the acceleration start point 108. Thereby, the driver can perform an acceleration operation at the acceleration start point 108 without worrying about the preceding vehicle 109.

The acceleration start point 108 may be changed based on the speed of the vehicle 2, the driver characteristics information, and the merging lane information. Thereby, when the vehicle speed of the vehicle 2 is low, for example, the acceleration notification is performed earlier, whereby a sufficient time can be ensured for the driver to perform an acceleration operation. Also, the acceleration notification is performed earlier for drivers who are not good at accelerating. Further, the acceleration notification is performed earlier in the case where the merging lane 103 has an upward gradient or has a small radius of curvature.

After the vehicle 2 has reached the mergeable section 103B, the control device 17 does not cause the notification device 20 to execute the acceleration notification or the inter-vehicle distance increase notification, and therefore, the driver can concentrate on the lane change to the main lane 101.

The embodiment may be modified in various ways without being limited to the above-described configuration. For example, a configuration may be made such that the offset distance LO can be selected by the driver. A selection switch may be provided on the instrument panel 32 or the like to allow the selection of the offset distance LO.

The control device 17 may execute preceding vehicle following control, which may also be called adaptive cruise control, in which the control device 17 controls the propulsion device 5 and the braking device 6 based on the target vehicle speed and the target inter-vehicle distance, such that the inter-vehicle distance to the preceding vehicle 109 becomes the target inter-vehicle distance. In this case, the above-described driving assistance control may be performed simultaneously with the preceding vehicle following control. When the inter-vehicle distance increase notification is performed based on the driving assistance control during execution of the preceding vehicle following control, the driver should preferably operate a switch to increase the target inter-vehicle distance of the preceding vehicle following control. Also, the control device 17 may set the first target inter-vehicle distance or the second target inter-vehicle distance set in the driving assistance control as the target inter-vehicle distance of the preceding vehicle following control. Thereby, the preceding vehicle following control executed by the control device 17 can function to maintain the inter-vehicle distance at the first target inter-vehicle distance before the acceleration start point 108, and to maintain the inter-vehicle distance is at the second target inter-vehicle distance between the acceleration start point 108 and the merging start point 107.

When the acceleration notification is performed based on the driving assistance control during execution of the preceding vehicle following control, the driver should preferably depress the accelerator pedal thereby to override the preceding vehicle following control and accelerate the vehicle 2. When the accelerator pedal is depressed during the preceding vehicle following control, the control device 17 should preferably control the propulsion device 5 according to the depression amount of the accelerator pedal, overriding the preceding vehicle following control. Also, when the acceleration start point is reached, the control device 17 may change the target vehicle speed of the preceding vehicle following control to a predetermined merging vehicle speed, thereby to cause the vehicle 2 to accelerate under the preceding vehicle following control. The merging vehicle speed is preferably a value obtained by lowering the speed limit of the main lane 101 by 10 to 30 km/h, for example.

The above embodiment may be described as follows.

One embodiment is a driving assistance device 1 for a vehicle 2, the driving assistance device 1 comprising: a notification device 20 provided in a cabin 25 of the vehicle 2; and a control device 17 that controls the notification device 20, wherein the control device 17 is configured to set, on a merging lane 103 that merges with a main lane 101, an acceleration start point 108 before a merging start point 107 where a lane change from the merging lane 103 to the main lane 101 becomes possible, and cause the notification device 20 to output an acceleration notification that prompts a driver to perform an acceleration operation when the vehicle 2 reaches the acceleration start point 108.

According to this aspect, the driving assistance device 1 that can prompt the driver to accelerate appropriately on the merging lane 103 can be provided. The driver can perform an acceleration operation at an appropriate timing on the merging lane 103 based on the acceleration notification. Also, since the acceleration start point 108 is set before the merging start point 107, the driver performs an acceleration operation at a relatively early timing based on the acceleration notification. Thereby, the vehicle 2 driven by the driver is caused to accelerate at a timing earlier than the following vehicle. As a result, it is possible to widen the inter-vehicle distance between the vehicle 2 driven by the driver and the following vehicle by using the reaction delay of the following vehicle.

In the above embodiment, when the vehicle 2 is positioned before the acceleration start point 108 on the merging lane 103 and an inter-vehicle distance between the vehicle 2 and a preceding vehicle 109 thereof is smaller than a first target inter-vehicle distance, the control device 17 may cause the notification device 20 to output an inter-vehicle distance increase notification that prompts the driver to increase the inter-vehicle distance, and when the vehicle 2 is positioned between the acceleration start point 108 and the merging start point 107 on the merging lane 103 and the inter-vehicle distance between the vehicle 2 and the preceding vehicle 109 thereof is smaller than a second target inter-vehicle distance, the control device 17 may cause the notification device 20 to output the inter-vehicle distance increase notification, the first target inter-vehicle distance being set greater than the second target inter-vehicle distance.

According to this aspect, before the vehicle 2 reaches the acceleration start point 108, the driver can perform an operation to increase the inter-vehicle distance to the preceding vehicle 109 based on the inter-vehicle distance increase notification. As a result, a sufficient inter-vehicle distance can be ensured between the preceding vehicle 109 and the vehicle 2 at the acceleration start point 108. Thereby, the driver can perform an acceleration operation at the acceleration start point 108 without worrying about the preceding vehicle 109.

In the above embodiment, the control device 17 may set the acceleration start point 108 such that the lower a speed of the vehicle 2 is relative to a predetermined target speed, the greater a distance between the acceleration start point 108 and the merging start point 107 is.

According to this aspect, when the vehicle speed of the vehicle 2 is low, the acceleration notification is performed earlier, whereby a sufficient time can be ensured for the driver to perform an acceleration operation.

In the above embodiment, the control device 17 may set the acceleration start point 108 based on driver characteristics information.

According to this aspect, the acceleration notification is performed at an appropriate timing according to the driver's characteristics.

In the above embodiment, the control device 17 may set the acceleration start point 108 based on merging lane information including at least one of a radius of curvature and a gradient of the merging lane 103.

According to this aspect, the acceleration notification is performed at an appropriate timing according to at least one of the radius of curvature and the gradient of the merging lane 103.

In the above embodiment, the control device 17 may cause the notification device 20 to output a preparation notification that prompts the driver to prepare for an acceleration operation when a distance between the vehicle 2 and the acceleration start point 108 becomes less than or equal to a predetermined determination value.

According to this aspect, the driver can prepare for an acceleration operation based on the preparation notification.

Another embodiment is a driving assistance method for a vehicle 2, wherein the driving assistance method is to be executed by a computer and comprises: setting, on a merging lane 103 that merges with a main lane 101, an acceleration start point 108 before a merging start point 107 where a lane change from the merging lane 103 to the main lane 101 becomes possible; and causing a notification device 20 to output an acceleration notification that prompts a driver to perform an acceleration operation when the vehicle 2 reaches the acceleration start point 108.

According to this aspect, a driving assistance method that can prompt the driver to accelerate appropriately on the merging lane 103 can be provided.

Another embodiment is a non-transitory computer-readable storage medium, comprising a stored control program, the control program configured to cause a computer to execute a driving assistance method for a vehicle 2, the driving assistance method comprising: setting, on a merging lane 103 that merges with a main lane 101, an acceleration start point 108 before a merging start point 107 where a lane change from the merging lane 103 to the main lane 101 becomes possible; and causing a notification device 20 to output an acceleration notification that prompts a driver to perform an acceleration operation when the vehicle 2 reaches an acceleration start point 108.

According to this aspect, a control program for causing a computer to execute a driving assistance method that can prompt the driver to accelerate appropriately on the merging lane 103 can be provided.

1. A driving assistance device for a vehicle, the driving assistance device comprising:
a notification device provided inside a cabin of the vehicle; and
a control device that controls the notification device,
wherein the control device is configured to
set, on a merging lane that merges with a main lane, an acceleration start point before a merging start point where a lane change from the merging lane to the main lane becomes possible, and
cause the notification device to output an acceleration notification prompting a driver to perform an acceleration operation when the vehicle arrives at the acceleration start point.

2. The driving assistance device according to claim 1, wherein when the vehicle is positioned before the acceleration start point on the merging lane and an inter-vehicle distance between the vehicle and a preceding vehicle thereof is smaller than a first target inter-vehicle distance, the control device causes the notification device to output an inter-vehicle distance increase notification that prompts the driver to increase the inter-vehicle distance, and
when the vehicle is positioned between the acceleration start point and the merging start point on the merging lane and the inter-vehicle distance between the vehicle and the preceding vehicle thereof is smaller than a second target inter-vehicle distance, the control device causes the notification device to output the inter-vehicle distance increase notification,
the first target inter-vehicle distance being set greater than the second target inter-vehicle distance.

3. The driving assistance device according to claim 1, wherein the control device sets the acceleration start point such that the lower a speed of the vehicle is relative to a predetermined target speed, the greater a distance between the acceleration start point and the merging start point is.

4. The driving assistance device according to claim 1, wherein the control device sets the acceleration start point based on driver characteristics information.

5. The driving assistance device according to claim 1, wherein the control device sets the acceleration start point based on merging lane information including at least one of a radius of curvature and a gradient of the merging lane.

6. The driving assistance device according to claim 1, wherein the control device causes the notification device to output a preparation notification that prompts the driver to prepare for an acceleration operation when a distance between the vehicle and the acceleration start point becomes less than or equal to a predetermined determination value.

7. A driving assistance method for a vehicle, wherein the driving assistance method is to be executed by a computer and comprises:
setting, on a merging lane that merges with a main lane, an acceleration start point before a merging start point where a lane change from the merging lane to the main lane becomes possible; and
causing a notification device to output an acceleration notification prompting a driver to perform an acceleration operation when the vehicle arrives at the acceleration start point.

8. A non-transitory computer-readable storage medium, comprising a stored control program, the control program configured to cause a computer to execute a driving assistance method for a vehicle, the driving assistance method comprising:
setting, on a merging lane that merges with a main lane, an acceleration start point before a merging start point where a lane change from the merging lane to the main lane becomes possible; and
causing a notification device to output an acceleration notification prompting a driver to perform an acceleration operation when the vehicle arrives at the acceleration start point.
